(19) United States
(12) Patent Application Publication
(10) Pub. No.: US 2013/0144653 A1
(43) Pub. Date: Jun. 6, 2013

(54) SYSTEM AND METHOD FOR VISUALIZING PATIENT TREATMENT HISTORY IN A NETWORK ENVIRONMENT

(71) Applicant: Net.Orange, Inc., Dallas, TX (US)

(72) Inventors: Gregory J. Poe, Dallas, TX (US); Vasu Rangadass, Arlington, TX (US); Ravi Seshadri, Plano, TX (US)

(73) Assignee: NET.ORANGE, INC., Dallas, TX (US)

(21) Appl. No.: 13/753,092

(22) Filed: Jan. 29, 2013

Related U.S. Application Data
(63) Continuation-in-part of application No. 12/536,060, filed on Aug. 5, 2009.
Application No. 12/536,060 is a continuation-in-part of application No. 12/816,804, filed on Jun. 16, 2010.
Application No. 12/816,804 is a continuation-in-part of application No. 12/536,060, filed on Aug. 5, 2009.
(60) Provisional application No. 61/086,344, filed on Aug. 5, 2008.
(60) Provisional application No. 61/086,344, filed on Aug. 5, 2008.

(51) Int. Cl. G06F 19/00

(52) U.S. Cl. CPC G06F 19/322
USPC 705/3

(57) ABSTRACT

A method is provided in one example embodiment and includes receiving a request from a client for medical data in a network environment, generating data rendering instructions for rendering the medical data as a visual display at the client, delivering the data rendering instructions to the client and facilitating access to the medical data by the client. The data rendering instructions include options to configure the visual display, which includes a graphical representation of the medical data displayed according to a plurality of encounters, and visual aids that reveal information upon user selection. The visual display further includes an action icon associated with each encounter, and the action icon is selectable to indicate one or more actions taken during the associated encounter. In specific embodiments, the request is sent by a browser of the client that accesses and renders the medical data according to the data rendering instructions.

### CROSS-REFERENCE TO RELATED APPLICATION

This application is a continuation-in-part and claims the benefit of priority under 35 U.S.C. §120 to U.S. application Ser. No. 12/536,060, entitled “Operating System” filed Aug. 5, 2009, which application claims the benefit of priority to U.S. Provisional Application Ser. No. 61/086,344, entitled “Operating System” filed Aug. 5, 2008. This application is also a continuation-in-part and claims the benefit of priority under 35 U.S. §120 to U.S. application Ser. No. 12/816,804, entitled “Operating System” filed Jun. 16, 2010, which application is a continuation-in-part of Ser. No. 12/536,060, entitled “Operating System” filed Aug. 5, 2009, which application in turn claims the benefit of priority to U.S. Provisional Patent Application Ser. No. 61/086,344, entitled “Operating System” filed Aug. 5, 2008. The disclosures of the prior applications are considered part of, and are incorporated by reference in their entireties in, the disclosure of this application.

### TECHNICAL FIELD

This disclosure relates in general to the field of healthcare systems and, more particularly, to a system and a method for visualizing patient treatment history in a network environment.

### BACKGROUND

Paper-based medical records have been in existence for centuries and are being gradually replaced by computer-based records in modern healthcare systems. Hospitals are increasingly using electronic medical records (EMRs), electronic health records (EHRs), electronic patient records (EPRs), computer-based patient records (CPRs), etc. to capture and manage patients' medical and health information electronically. As of 2002, there were five different types of personal health records: (i) off-line personal health record; (ii) web-based commercial personal health record; (iii) web-based functional personal health record; (iv) provider based personal health record; and (v) web-based partial personal health record. Except for the provider based personal health record, all the other types of personal health records were created by the patient or by third parties, not including the health provider. The types and formats of health records have increased exponentially since 2002, and there currently exists myriad, diverse electronic representations of health and medical records from a wide variety of medical systems and other sources.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating a healthcare monitoring system for visualizing patient treatment history in a network environment according to an example embodiment;

FIG. 2 is a simplified diagram illustrating example details of an embodiment of the healthcare monitoring system;

FIG. 3 is a simplified block diagram illustrating yet other example details of an embodiment of the healthcare monitoring system;

FIG. 4 is a simplified flow diagram illustrating example operations that may be associated with an embodiment of the healthcare monitoring system;

FIG. 5 is a simplified flow diagram illustrating other example operations that may be associated with an embodiment of the healthcare monitoring system;

FIG. 6 is a simplified flow diagram illustrating yet other example operations that may be associated with an embodiment of the healthcare monitoring system; and

FIG. 7 is a simplified flow diagram illustrating yet other example operations that may be associated with an embodiment of the healthcare monitoring system.

### DETAILED DESCRIPTION OF EXAMPLE EMBODIMENTS

### Overview

A method for visualizing patient treatment history in a network environment is provided in one example embodiment and includes receiving a request from a client for medical data in a network environment, generating data rendering instructions for rendering the medical data as a visual display at the client, delivering the data rendering instructions to the client and facilitating access to the medical data by the client. The data rendering instructions can include options to configure the visual display, which can include a graphical representation of the medical data displayed according to a plurality of encounters, and visual aids that reveal information upon user selection.

In specific embodiments, the visual display can further include an action icon associated with each encounter, and the action icon may be selectable to reveal one or more actions taken during the associated encounter. At least one data point of the graphical representation may be selectable to reveal details about the data point. In an example embodiment, the visual display is configurable to display the medical data according to a plurality of dates corresponding to the encounters. The visual display can be configurable to show a first item of the medical data plotted along a primary axis and a second item of the medical data plotted along a secondary axis. The visual display can also be configurable to show or hide an intelligent trend report, comprising an automatically calculated trend of the medical data in the visual display.

According to some embodiments, the graphical representation indicates a type of each encounter, where the type of encounter is at least one selected from a group comprising: clinic, hospital, laboratory, web, imaging center, and other. In an example embodiment, the visual display includes a depiction of a target, and the graphical representation indicates whether the target has been met.

In specific embodiments, the request is sent by a browser of the client that accesses and renders the medical data according to the data rendering instructions. The browser updates the visual display according to configuration changes by a user input. The method includes other features in various embodiments.

### EXAMPLE EMBODIMENTS

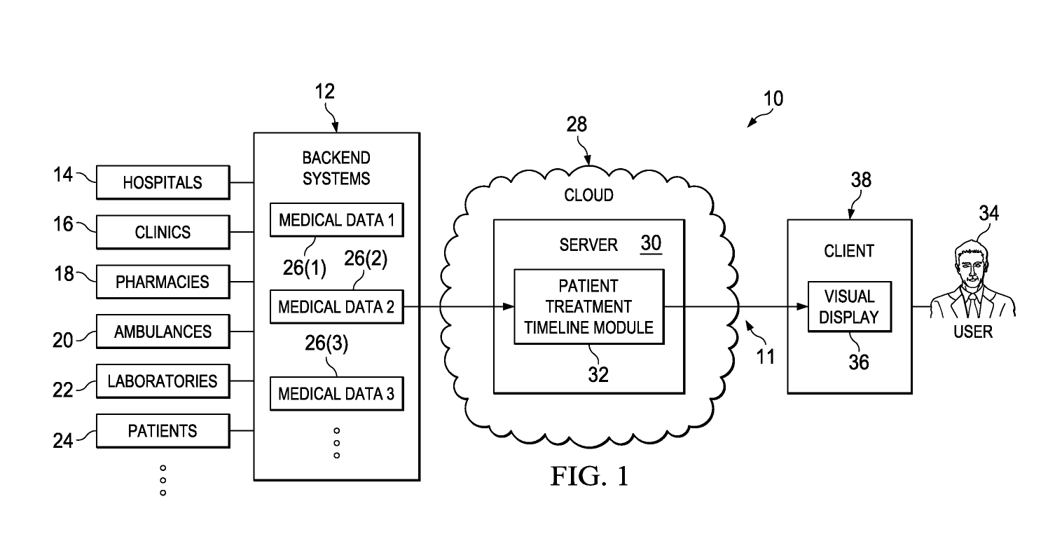

Turning to FIG. 1, FIG. 1 is a simplified block diagram illustrating a healthcare monitoring system 10 for visualizing patient treatment history in a network environment. Healthcare monitoring system 10 includes a network 11 (generally indicated by an arrow) comprising backend systems 12 that may be associated with myriad data sources, including hospitals 14, clinics 16, pharmacies 18, ambulances 20, laboratories 22, patients 24, etc. The examples of medical data sources provided herein are merely for ease of illustration, and are not intended to be limitations. Virtually any type and number of medical data sources may be encompassed in the broad scope of the embodiments.

The various medical data sources may generate or provide medical data 26, for example, medical data 26(1)-26(3) comprising various pieces of information in various formats. As used herein, the term “medical data” includes information (e.g., facts) related to diagnosis and treatment of a current or potential health condition (e.g., disease, diabetes, obesity, aging, etc.). Medical data 26 includes health information of an individual (e.g., information pertaining to the health of the individual or health care provided to the individual) collected from the individual at one or more of medical data sources, including hospitals 14, nursing homes, medical centers, clinic 16, health or nursing agencies, health care facilities, or medical data provided by the patients 24, or relatives and friends of the patient.

Medical data 26 can include demographic information (e.g., age, weight, gender) that may be relevant to diagnosis and treatment of a current or potential health condition. Medical data 26 may be generated during encounters (e.g., visit at physician's office, laboratory testing, in-home testing). In a general sense, data, including medical data 26, refers to any type of numeric, text, voice, video, or script data, or any type of source or object code, or any other suitable information in any appropriate format that may be communicated from one point to another in electronic devices and/or networks. Backend systems 12 may communicate medical data 26 to a cloud 28 comprising a server 30 provisioned with a patient treatment timeline module 32. According to various embodiments, patient treatment timeline module 32 may enable a user 34 to view medical data 26 on a suitable visual display 36 at client 38.

For purposes of illustrating the techniques of healthcare monitoring system 10, it is important to understand the communications in a given system such as the system shown in FIG. 1. The following foundational information may be viewed as a basis from which the present disclosure may be properly explained. Such information is offered earnestly for purposes of explanation only and, accordingly, should not be construed in any way to limit the broad scope of the present disclosure and its potential applications.

The development of an Information Technology (IT) infrastructure in healthcare delivery has enormous potential to improve the safety, quality, and efficiency of health care and health delivery. Computer-assisted diagnosis can improve clinical decision making. Computer-based reminder systems can improve compliance with preventive service protocols. Immediate access to computer-based clinical information, such as laboratory and radiology results can improve quality of healthcare delivery. Likewise, the availability of complete patient health information at the point of care delivery, clinical decision support systems and other computer-assisted healthcare monitoring systems can prevent many errors and adverse events. Patient health information can be shared among all authorized participants in the health care community via secure IT infrastructure

Computer based systems for health care delivery typically use electronic health records (EHRs) to store patient information. EHRs typically include data in text format (e.g., physician notes), images (X-rays), numerals (e.g., patient weight), tables, etc., which can require additional analysis for decision making. Consider the example of a patient who has a medical checkup on Jun. 1, 2010, when her fasting blood glucose level is measured to be 200 mg/dL and her weight is 130 lbs. A medication based treatment is prescribed to lower the blood glucose level. Another medical checkup on Jun. 1, 2011 indicates a fasting blood glucose level of 250 mg/dL, and a weight of 150 lbs. Yet another medical checkup on Jun. 1, 2012 indicates a fasting blood glucose level of 200 mg/dL and a weight of 155 lbs.

A physician viewing the medical data may have to perform further analysis on the data to determine if the medication based treatment is successful. Such further analysis may involve mentally computing the rate of change of the blood glucose level over time, charting the data manually on a graph, etc. If the medication had a side effect of weight gain, the physician may have to perform additional analysis to reach the conclusion. Moreover, if the medication adversely affects yet other aspects of the patient, it would be even more difficult for the physician to determine the proper effect of the treatment and the complex interactions of the medication on the patient as a whole. Further, if the patient has other medical conditions (e.g., heart disease), it may be still more difficult to ascertain the impact of a combined medication regimen for both conditions, or the separate effect of each individual medication.

Moreover, a patient viewing the textual EHR information may fail to understand key aspects of the numeric information that is presented simply as text. Many patients may have limited numeracy skills, discomfort with numerical expressions of risk, and analytic reasoning processes impaired by age and disease or other medical conditions. However, analysis of the medical data may be imperative to risk communication for shared medical decision-making, informed consent, health risk appraisal, counseling about difficult decisions (such as pertaining to cancer or genetic screening), and other medical treatment actions. Effective risk communication can improve awareness of health risks and promote behavior in support of health promotion and disease prevention.

Graphical displays in such context can permit individuals (physicians, patients and other caregivers) to quickly comprehend response patterns to therapy and treatments. Graphs can present medical data in a visually interesting format, and exploit rapid, automatic visual perception skills. A well designed visual display can reduce the amount of mental computation by replacing it with automatic visual perception. Graphs can reveal data patterns that may go undetected otherwise. For example, line graphs can efficiently convey trends in data, pie charts and divided bar graphs can depict proportions, etc. Specific graph types may evoke automatically specific mathematical operations. For example, given a particular task (e.g., comparing risks), certain graphs allow the observer to process the information more effectively than when numbers are presented alone. Moreover, unlike numbers, graphs can attract and hold people's attention because they display information in concrete, visual terms. However, if the graphs are not well designed, some aspects of graph interpretation can require more effortful cognitive skills such as interpretation and calculation, prone to misinterpretation and leading to erroneous decisions.

A challenge in presenting a proper visual display that can give sufficient information to appropriate users (e.g., physicians, patients, etc.) is to provide the information in a visually appealing manner while simultaneously maximizing the amount of information presented. Many existing electronic health record (EHR) systems provide a peep-hole view of the individual's health history, for example, presenting only a portion of the data to physicians. Reasons for such partial display of health history can range from lack of access to relevant data, to lack of computing resources and mechanisms to display the data efficiently.

Healthcare monitoring system 10 is configured to address these issues (and others) in offering a system and a method for visualizing patient treatment history in a network environment. Embodiments of healthcare monitoring system 10 can provide a suitable visual display 36 of medical data 26. In various embodiments, client 38 may request medical data 26 from cloud 28. Patient treatment timeline module 32 may respond with data rendering instructions to client 38. The data rendering instructions may allow client 38 to access medical data 26 and display it suitably as visual display 36.

Visual display 36 may present multiple types and levels of information in a visually pleasing manner according to encounter. As used herein, an “encounter” includes an interaction between a healthcare professional (e.g., physician, nurse, caregiver, laboratory technician, imaging specialist, pharmacist, etc.) and a patient for the purpose of diagnosis and/or treatment of a medical condition (e.g., illness, surgery, injury, etc.). The interaction may include in person interactions (e.g., face-to-face interactions) or via a communication technology (e.g., phone, email, web-browser, etc.). The encounter may be an examination, a consultation, an intervention, a surgery, a physical therapy session, a dental cleaning session, etc.

Included in encounters are physician encounters (e.g., between a physician, podiatrist, ophthalmologist, or psychiatrist, and patient), mid-level practitioner encounters (e.g., between a physician assistant, or advanced practice nurse and patient), independent nursing encounters (e.g., between a registered nurse or licensed practical nurse and patient), laboratory encounters (e.g., between laboratory technicians and patient), dental encounters (e.g., between a dentist, dental assistant, dental hygienist, or oral therapist and patient), vision care encounter (e.g., between optometrist or optician and patient), radiology encounter (e.g., between a healthcare professional and patient to provide one or more imaging services), etc.

Encounters can include a patient taking a measurement by himself or herself, for example, measuring blood glucose level at home. Encounters can also include patient interaction with a web portal, for example, where the patient answers questions directed to his or her medical conditions, inputs readings of measured items, etc. In some embodiments, multiple encounters with the same health professional that take place on the same day can constitute a single encounter. In other embodiments, each such visit may be a separate encounter.

In a general sense, backend systems 12 can define and categorize encounters appropriately. For example, encounters involving patients on Medicare may be categorized according to federally defined encounter categories; encounters involving patients on private health insurance plans may be categorized according to the private insurer's categories; and so on. Medical data 26 provided by backend systems 12 may be appropriately tagged or otherwise identified as belonging to, or being associated with, a particular encounter. According to various embodiments, patient treatment timeline module 32 may accept any type and category of encounter provided by backend systems 12 and display associated medical data 26 according to the supplied encounter definitions. In cases where the encounter type or occurrence is not provided, patient treatment timeline module 32 may supply a default encounter category (e.g., “other”) for the associated medical data 26.

In an example embodiment, visual display 36 may provide a graph with a primary axis and a secondary axis, to chart two items (e.g., blood glucose level and weight) simultaneously. The graph may indicate the context of the items, for example, the date of measurement of the items, the type of encounter (e.g., clinic visit, in-home testing, etc.), actions taken at the encounter (e.g., X-rays at a radiology encounter, medications prescribed, etc.) and such other relevant information. Visual display 36 may be presented in an aesthetically pleasing manner, with visual aids that reveal information upon user selection.

“Visual aids,” as used herein, can include illustrative matter configured to supplement written information and can include colors, icons, and rollovers (e.g., buttons or other images that react when it is selected, for example, when the mouse cursor moves over them). Visual display 36 can provide a succinct chart that can be expanded to reveal relevant information at user 34's behest. For example, icons on the graph can reveal relevant medical data when the mouse cursor is rolled over the icons, or user 34 clicks on the icons, or otherwise selects the icons.

Turning to the infrastructure of healthcare monitoring system 10, the network topology of network 11 can include any number of servers, routers, gateways, and other nodes inter-connected to form a large and complex network. A node may be any electronic device, client, server, peer, service, application, or other object capable of sending, receiving, or forwarding information over communications channels in a network. Elements of FIG. 1 may be coupled to one another through one or more interfaces employing any suitable connection (wired or wireless), which provides a viable pathway for electronic communications. Additionally, any one or more of these elements may be combined or removed from the architecture based on particular configuration needs.

Healthcare monitoring system 10 may include a configuration capable of TCP/IP communications for the electronic transmission or reception of data packets in a network. Healthcare monitoring system 10 may also operate in conjunction with a User Datagram Protocol/Internet Protocol (UDP/IP) or any other suitable protocol, where appropriate and based on particular needs. In addition, gateways, routers, switches, and any other suitable nodes (physical or virtual) may be used to facilitate electronic communication between various nodes in the network.

Note that the numerical and letter designations assigned to the elements of FIG. 1 do not connote any type of hierarchy; the designations are arbitrary and have been used for purposes of teaching only. Such designations should not be construed in any way to limit their capabilities, functionalities, or applications in the potential environments that may benefit from the features of healthcare monitoring system 10. It should be understood that the healthcare monitoring system 10 shown in FIG. 1 is simplified for ease of illustration.

The example network environment may be configured over a physical infrastructure that may include one or more networks and, further, may be configured in any form including, but not limited to, local area networks (LANs), wireless local area networks (WLANs), virtual local area networks (VLANs), metropolitan area networks (MANs), wide area networks (WANs), virtual private networks (VPNs), Intranet, Extranet, any other appropriate architecture or system, or any combination thereof that facilitates communications in a network.

In some embodiments, a communication link may represent any electronic link supporting a LAN environment such as, for example, cable, Ethernet, wireless technologies (e.g., IEEE 802.11x), ATM, fiber optics, etc. or any suitable combination thereof. In other embodiments, communication links may represent a remote connection through any appropriate medium (e.g., digital subscriber lines (DSL), telephone lines, T1 lines, T3 lines, wireless, satellite, fiber optics, cable, Ethernet, etc. or any combination thereof) and/or through any additional networks such as a wide area networks (e.g., the Internet).

In various embodiments, server 30 may be provisioned with a suitable operating system (or platform, or other appropriate software) that can aggregate medical data 26, convert it from disparate formats to a uniform format (e.g., XML based format), and store medical data 26 in a suitable data store in cloud 28. The operating system may comprise a plurality of self-contained interconnected modules and service layers for connecting proprietary (and public) systems together and extracting and translating data therefrom to enable them to cooperate in a software ecosystem while allowing flexible connections with both existing and new applications.

According to various embodiments, server 30 includes a software program, or a computing device on which the program runs, that provides a specific kind of service to client software (e.g., client 38) running on the same computing device or other computing devices on network 11. Client 38 may include any electronic device, client, server, peer, service, application, or other object capable of sending, receiving, or forwarding information over a network (e.g., network 11). Examples of client 38 include computers, laptops, smart phones, printers, etc. Client 38 may be provisioned with suitable interfaces (e.g., web browsers) that can render medical data 26, including browser code. In a general sense, client 38 may provide a user interface, such as a graphical user interface (GUI), and perform some or all of the processing on requests it makes from server 30, which maintains the data (e.g., medical data 36) and processes the requests. For ease of illustration, only one server 30 and one client 38 are illustrated in the FIGURE. Virtually any number of servers and clients may be included in healthcare monitoring system 10 within the broad scope of the embodiments.

In some embodiments, patient treatment timeline module 32 may be an application installed on server 30 located in a network (e.g., cloud 28) remote from backend systems 12 and client 38. As used herein, the term “application” can be inclusive of an executable file comprising instructions that can be understood and processed on a computer, and may further include library modules loaded during execution, object files, system files, hardware logic, software logic, or any other executable modules. In other embodiments, patient treatment timeline module 32 may be installed on server 30 located in the same local area network as backend systems 12 and/or client 38. In some embodiments, patient treatment timeline module 32 may be installed on a single computer or server; in other embodiments, patient treatment timeline module 32 may be a distributed application residing on a plurality of devices, including virtual machines. Various hardware and software implementations are possible for patient treatment timeline module 32, all of which are encompassed within the broad scope of the embodiments.

Backend systems 12 can include various computers, measuring instruments, public and proprietary software applications and systems and such other hardware and software components that facilitate operating with myriad medical data sources (e.g., hospitals 14, clinics 16, etc.) and communicating medical data 26 with cloud 28. Backend systems 12 may present various disparate operating systems and platforms to server 30, including EMRs, hospital information systems (HIS), lab and pathology systems (LIS), imaging systems (PACS, RIS), pharmacy systems, scheduling systems, medical devices, etc. In some embodiments, each medical data source may be a separate system, with its own computer network, data format and proprietary applications. In other embodiments, substantially all medical data sources may be part of a single system (e.g., enterprise network, software, etc.) that can interface with each other and with backend systems 12.

Cloud 28 is a collection of hardware and software forming a shared pool of configurable computing resources (e.g., networks, servers, storage, applications, services, etc.) that can be suitably provisioned to provide on-demand self-service, network access, resource pooling, elasticity and measured service, among other features. Cloud 28 may be deployed as a private cloud (e.g., infrastructure operated by a single enterprise/organization), community cloud (e.g., infrastructure shared by several organizations to support a specific community that has shared concerns), public cloud (e.g., infrastructure made available to the general public), or a suitable combination of two or more disparate types of clouds. Cloud 28 may be managed by a cloud service provider, who can provide subscribers (e.g., client 38) with at least access to cloud 28, and authorization to use cloud resources in accordance with predetermined service level agreements.

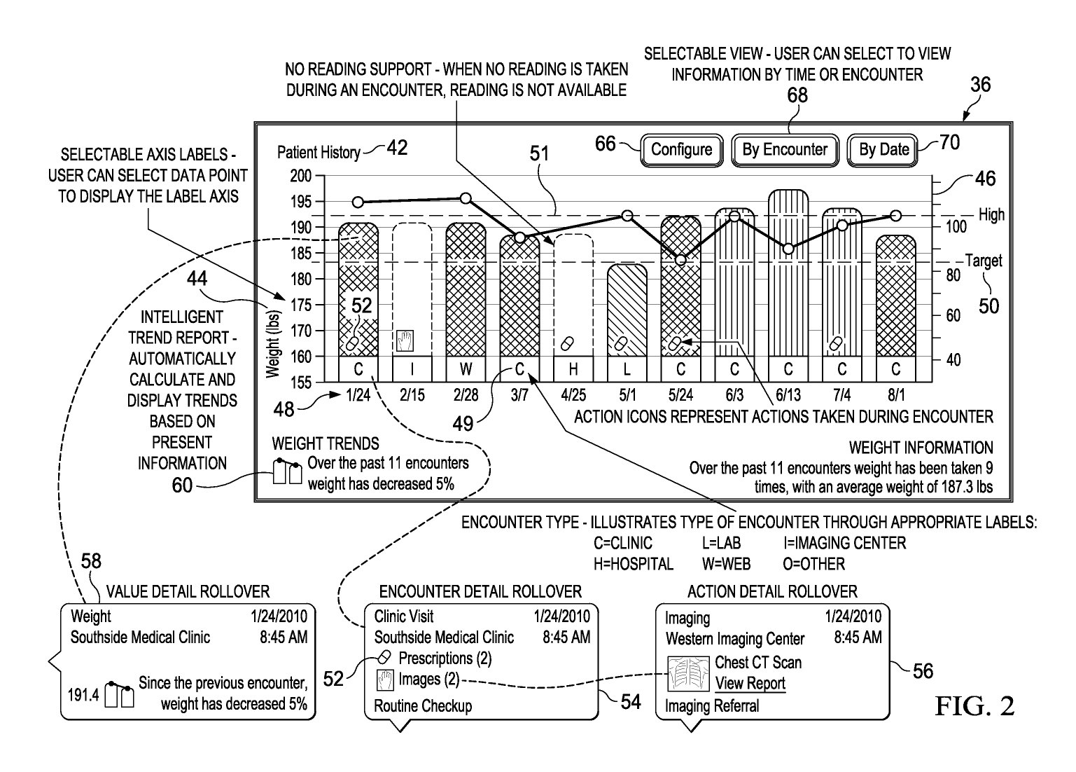

Turning to FIG. 2, FIG. 2 is a simplified diagram illustrating an example visual display 36 according to an embodiment of healthcare monitoring system 10. Visual display 36 may include a chart title 42 (e.g., “Patient History”), and a primary axis 44 that charts a first item (e.g., weight) and a secondary axis 46 that charts a second item (e.g., blood glucose level) over one or more encounters 48 (e.g., sorted according to date). Items can include medical data 26, or portions thereof. Primary axis 44 and secondary axis 46 may be user-selectable (e.g., by user 34), for example, through appropriate commands on a web browser, or selecting from a drop-down list, etc.

The scale and format of primary axis 44 and secondary axis 46 may also be configurable by user 34. In example visual display 36, primary axis 44 denotes weight along a scale from 155 lbs to 200 lbs. The readings are displayed as a bar chart, with weight along the primary Y-axis (vertical axis), and encounters along the X-axis (horizontal axis) according to date. Secondary axis 46 denotes blood glucose level along a scale from 40 mg/dL to 120 mg/dL. The readings are displayed as a line chart, with blood glucose level along the secondary Y-axis, and encounters along the X-axis according to date. The bar chart and line chart shown are merely examples; any graph format (e.g., line chart, pie chart, scatter plot, etc.) suitable for the item can be used within the broad scope of the embodiments.

Encounters 48 may represent various encounter types, identified by suitable labels 49. In various embodiments, user 34 may select a scale of encounters 48 (e.g., encounters occurring between and including 1/24 and 8/1). In example visual display 36, encounter label 49 includes C, denoting a reading (e.g., measurement) at a clinic visit; H, denoting a reading at a hospital visit; L, denoting a reading at a laboratory visit; W, denoting a reading entered over a web portal; I, denoting a reading at an imaging center; and O, denoting a reading entered in another manner. Any type of label may be suitably used, within the broad scope of the embodiments.

According to various embodiments, if a reading is not taken at an encounter, then visual display 36 may indicate that no reading is available for that encounter. In example visual display 36, transparent bars (or bars indicated in dotted lines) indicate that no reading is available for encounters on 2/15 (e.g., imaging encounter) and 4/25 (e.g., hospital encounter). Colors and other visual aids may also be used suitably to capture attention of user 34. A target 50 may be displayed to indicate a goal, or optimal vector reading, or other suitable indicator. In example visual display 36, reading at or below target 50 (e.g., reading on 5/1) may be indicated in green. A “high” indicator 51 may be displayed to indicate a high reading, for example, a reading that indicates unhealthy levels of the displayed item. In example visual display 36, readings on 6/3, 6/13 and 7/4 are above high indicator 51 and may be shown in red, for example, to alert user 34 that the readings are of concern.

An action icon 52 may be displayed in the chart for each of encounter 48, to indicate actions taken during the appropriate encounter. In some embodiments, each action icon 52 may represent a specific action. For example, an icon forming an image of a capsule may indicate prescriptions; an X-ray representation may indicate a radiology visit; a round-bottom flask may indicate a laboratory measurement; and so on. Any type and format of action icon 52 may be suitably used within the broad scope of the embodiments. In other embodiments, action item 52 may merely represent that certain actions were taken, without specifying their nature. In other words, action icon 52 may provide a succinct representation of one or more actions taken during the encounter.

In various embodiments, action icon 52 may indicate to user 34 that additional information may be revealed regarding the action. For example, moving the mouse cursor over action icon 52 may reveal details of the encounter, including the specific actions taken. An example encounter detail rollover 54 is shown in the FIGURE corresponding to the encounter/reading on 1/24. Example encounter detail rollover 54 may indicate details in a pop-up window, for example, indicating that the encounter was at Southside Medical Clinic, two medications were prescribed, and two images were taken. In an example embodiment, the information may be displayed using action icon 52 and summarized text (e.g., “prescriptions (2)”). Rolling the cursor over the images (or otherwise selecting action icon 52 corresponding to “Images”) in encounter detail rollover 54 may reveal further details, for example in an action detail rollover 56. Action detail rollover 56 may indicate that the image was a chest CT scan. A hyperlink to the CT Scan report may be included to allow user 34 to navigate to the CT scan and view the CT scan appropriately.

In some embodiments, user 34 can move the mouse cursor over the value of any specific data point to reveal a value detail rollover 58. Value detail rollover 58 may show the details of the specific data point, and any trends from previous readings, among other particulars. An overall trend from multiple readings may also be displayed on example visual display 36 as intelligent trend report 60, for example, in a bottom left-hand portion. Intelligent trend report 60 may automatically calculate and display trends based on presently available information gleaned from medical data 26 and displayed on visual display 36. Additional information 62 may also be included in visual display 36, for example, in a bottom right hand portion. Additional information 62 may include further calculations based on the available data, for example, average values of readings, number of readings, etc. displayed on visual display 36.

According to various embodiments, visual display 36 may be configured by clicking on (or otherwise selecting) a configuration option 66. Configuration option 66 may include a button, an icon, or other selectable link that can facilitate configuring visual display 36 by user 34 (e.g., at client 38). For example, user 34 may click on configuration option 66 and navigate to various options to change the primary axis item, scale, units, colors, etc. Selectable view options 68 and 70 may allow user 34 to select any one option to view medical data 26 accordingly. For example, by selecting “By Encounter” option 68, user 34 can view the item by encounters; by selecting “By Date” option 70, user 34 can view the item by date. Encounter and date are merely two example options provided in example visual display 36. Any option (e.g., year, specific encounter types, etc.) may be made available for user selection within the broad scope of the embodiments.

It may be noted that visual display 36 illustrated in the FIGURE is merely for example purposes. Visual display 36 may include other options and information based on the type of items displayed and the audience, for example, a role (e.g., physician, patient, hospital administrator, payor, etc.) of user 34. In an example embodiment, the options displayed may be different for a physician and a patient. Whereas the physician may be able to see medical details, terminologies, chemical compositions of medications, medical notes by other physicians and medical professionals, the patient may be able to see medications according to their common names, without medical terminologies or other jargon that could confuse the patient. In other embodiments, the options displayed may be the same for any user, irrespective of the role of user 34.

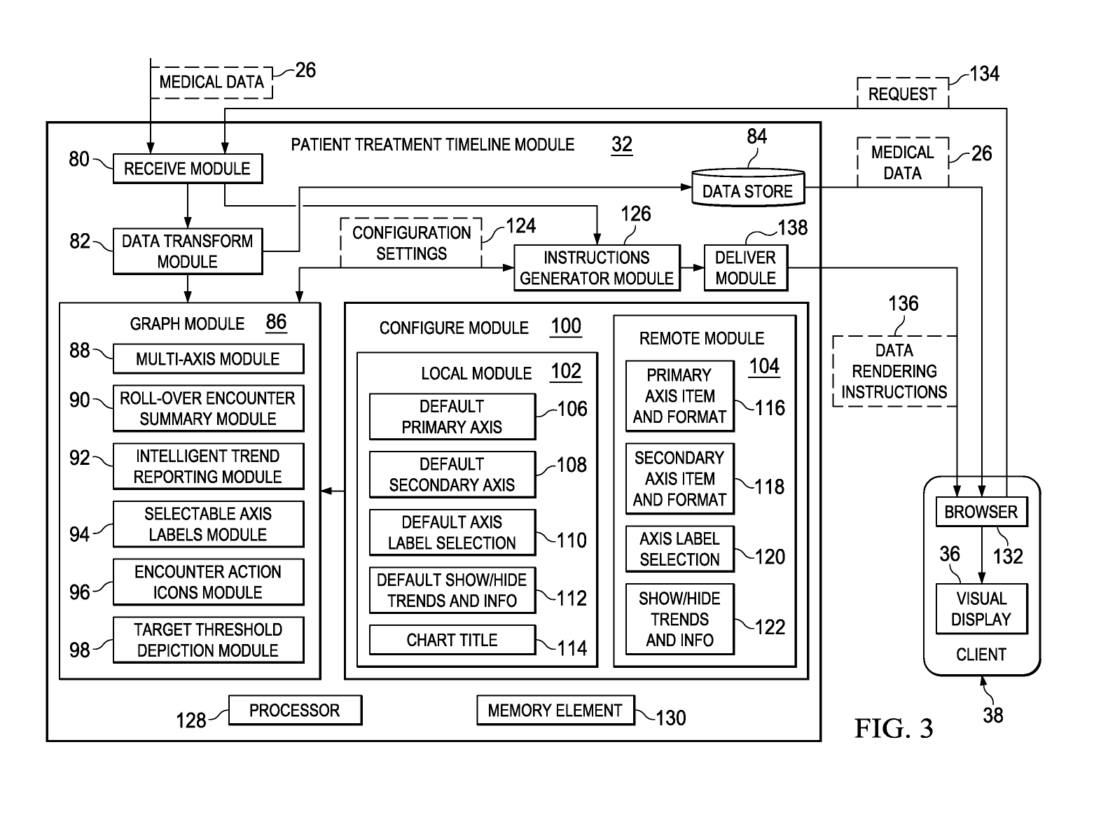

Turning to FIG. 3, FIG. 3 is a simplified block diagram illustrating example details according to an embodiment of healthcare monitoring system 10. Patient treatment timeline module 32 may receive medical data 26 at a receive module 80. Receive module 80 may be configured with appropriate network interfaces to communicate with backend systems 12 and receive medical data 26. A data transform module 82 may transform medical data 26 in any format (e.g., arrangement of data for storage, display, communication, printing, etc. such as hypertext markup language (HTML), text, and extensible markup language (XML)) into a uniform format (e.g., data arrangements that can be rendered on a common interface simultaneously, such as HTML format that can permit a web browser to render text and images simultaneously) and store the uniform format data in a data store 84.

A graph module 86 may facilitate preparing visual display 36. Graph module 86 may include a multi-axis module 88 that can permit multiple axes to be displayed simultaneously on visual display 36. A rollover encounter summary module 90 may enable rollovers such as encounter detail rollover 54, action detail rollover 56, and value detail rollover 58. An intelligent trend reporting module 92 may enable calculating trends in real time based on displayed data. A selectable axis labels module 94 may permit user 34 to select axis labels (and items such as health vectors) appropriately. For example, selectable axis labels module 94 may present items (e.g., health vectors) to be selected as labels. An encounters action icons module may permit display of action icons 52 on visual display 36. A target threshold depiction module 98 may facilitate display of target 48 and high 50 on visual display 36.

A configure module 100 may facilitate configuring visual display 36 by graph module 86 appropriately. Configure module 100 may include a local module 102 and a remote module 104. Local module 102 may permit configuration settings (e.g., default values) whereas remote module 104 may permit configuration changes by user 34 at client 38. A default primary axis module 106 may set default format, ranges and color for primary axis 44. A default secondary axis module 108 may set default format, ranges and color for the secondary axis. A default axis label selection 110 may configure visual display 36 to show default items based on selected medical data 26 to be displayed at client 38. For example, if user 34 selects to view weight and blood glucose levels, default axis labels may indicate weight to be on the primary axis and blood glucose levels to the on the secondary axis.

A default show/hide trends and info module 112 may permit intelligent trend report 60 and additional information 62 to be displayed or hidden on visual display 36. In one embodiment, intelligent trend report 60 and additional information 62 may be displayed by default on visual display 36. In another embodiment, intelligent trend report 60 and additional information 62 may be hidden by default on visual display 36. A chart title module 114 may set chart title 42 depending on the data being viewed.

Remote module 104 may permit user configuration for primary axis 44 by primary axis item and format module 116. Remote module 104 may permit user configuration for the secondary axis by secondary axis item and format module 118. Remote module 104 may permit user configuration for axis labels by axis label selection module 120. Remote module 104 may permit user configuration for intelligent trend report 60 and additional information 62 by show/hide trends and info module 122. Configuration settings 124 prepared by graph module 86 may be provided to an instructions generator module 126. A processor 128 and a memory element 130 may facilitate the operations described herein. In various embodiments, processor 128 and memory element 130 may be part of server 30; in other embodiments, processor 128 and memory element 130 may be part of patient treatment timeline module 32, which may be embedded in server 30.

During operation, a browser 132 of client 38 may send a request 134 to patient treatment timeline module 32 for medical data 26. Receive module 80 may receive request 134 and inform instructions generator module 126 of request 134. Instructions generator module 124 may generate data rendering instructions 136 according to the configuration settings 124. Data rendering instructions 136 may include configuration options by remote module 104 that can permit user 34 to change the displayed values and format. Data rendering instructions 136 may include location of medical data 26 to be displayed, among other features. In an example embodiment, data rendering instructions 136 may be an XML file, with definitions for selected items to be displayed. A delivery module 138 may deliver data rendering instructions 136 to client 38. Browser 132 at client 38 may receive data rendering instructions 136. Accordingly, browser 132 may pull medical data 26 stored in data store 84 and display it on visual display 36 according to data rendering instructions 136.

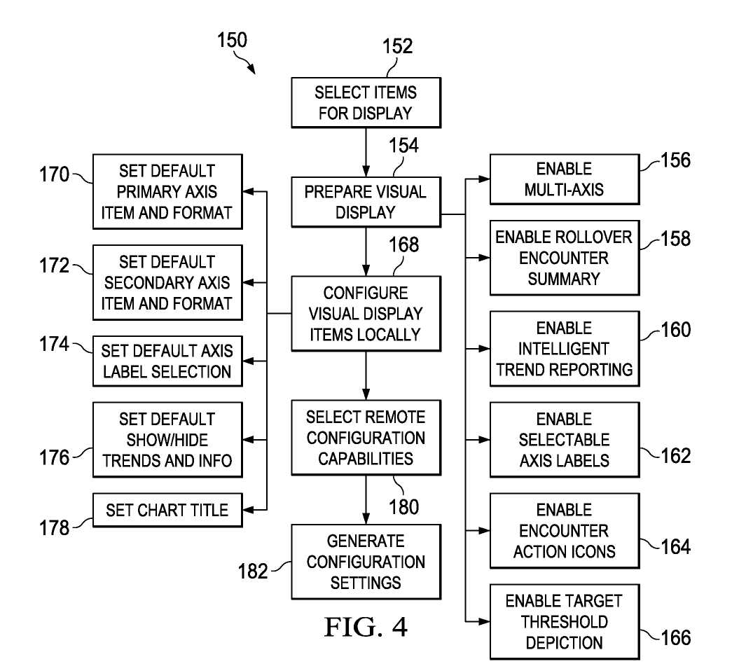

Turning to FIG. 4, FIG. 4 is a simplified flow diagram illustrating example operations that may be associated with generating visual display 36 according to an embodiment of healthcare monitoring system 10. Operations 150 may include 152, at which items may be selected for display. For example, certain items (e.g., weight, heart rate, blood pressure, etc.) may be selected by a system administrator (e.g., developer, IT manager, etc.) for display. In some embodiments, the items selected at 152 may not be changed by user 34 (e.g., physician, patient, etc.) later. At 154, visual display 36 may be prepared according to various operations, including 156, at which multi-axis may be enabled; 158, at which rollover encounter summary may be enabled; 160, at which intelligent trend reporting may be enabled; 162, at which selectable axis labels may be enabled; 164, at which encounter action icons may be enabled; and 166, at which target threshold depiction may be enabled.

At 168, visual display items may be locally configured (e.g., by local module 102). Local configuration may include setting default primary axis item and format at 170; setting default secondary axis item and format at 172; setting default axis label selection at 174; setting default show/hide intelligent trend report 60 and additional information 62 at 176 and setting chart title 42 at 178. At 180, remote configuration capabilities may be selected. At 182, configuration settings 124 may be generated. Configuration settings 124 may include substantially all configuration options, values, selections, choices, etc. that may be used to render visual display 36.

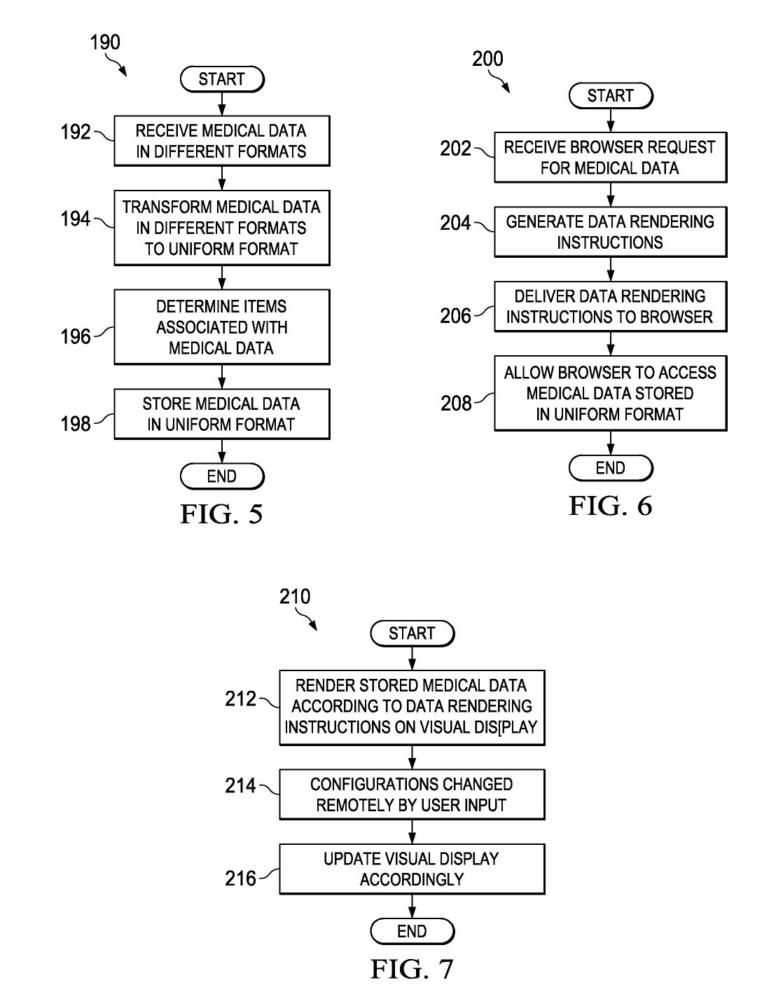

Turning to FIG. 5, FIG. 5 is a simplified flow diagram illustrating example operations that may be associated with an embodiment of healthcare monitoring system 10. Operations 190 may include 192, at which medical data 26 may be received in different formats. At 194, medical data 26 in different formats may be converted to a uniform format. At 196, items associated with medical data 26 may be determined. For example, medical data 26(1) may be determined to be a weight reading of patient X taken at Southside medical clinic on 1/24; medical data 26(2) may be determined to be a chest CT scan of the same patient; and so on. At 198, medical data 26 in uniform format may be stored in data store 84.

Turning to FIG. 6, FIG. 6 is a simplified flow diagram illustrating example operations that may be associated with embodiments of healthcare monitoring system 10. Operations 200 include 202, at which request 134 for medical data 26 may be received from browser 132. At 204, data rendering instructions 136 may be generated. At 206, data rendering instructions 136 may be delivered to browser 132. At 208, browser 132 may be allowed to access medical data 26 stored in data store 84 in uniform format.

Turning to FIG. 7, FIG. 7 is a simplified flow diagram illustrating example operations associated with browser 132 according to an embodiment of healthcare monitoring system 10. Operations 210 include 212, at which browser 132 may render stored medical data 26 according to data rendering instructions 136 on visual display 36. At 214, configurations of visual display 36 may be changed remotely by user input. For example, the user input may specify that the primary axis be changed from weight to blood glucose level. At 212, browser 132 may update visual display 36 accordingly. In some embodiments, the change in configuration may result in recalculating certain values, such as intelligent trend report 60, or additional information 62. Such recalculations may be performed at client 38 in some embodiments; in other embodiments, the instructions to recalculate may be sent to patient treatment timeline module 32, which may recalculate the trend and deliver the result to browser 132.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

In example implementations, at least some portions of the activities outlined herein may be implemented in software in, for example, patient treatment timeline module 32. In some embodiments, one or more of these features may be implemented in hardware, provided external to these elements, or consolidated in any appropriate manner to achieve the intended functionality. The various network elements may include software (or reciprocating software) that can coordinate in order to achieve the operations as outlined herein. In still other embodiments, these elements may include any suitable algorithms, hardware, software, components, modules, interfaces, or objects that facilitate the operations thereof.

Furthermore, patient treatment timeline module 32 described and shown herein (and/or its associated structures) may also include suitable interfaces for receiving, transmitting, and/or otherwise communicating data or information in a network environment. Additionally, some of the processors and memory elements associated with the various nodes may be removed, or otherwise consolidated such that a single processor and a single memory element are responsible for certain activities. In a general sense, the arrangements depicted in the FIGURES may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

In some of example embodiments, one or more memory elements (e.g., memory element 130, data store 84) can store data used for the operations described herein. This includes the memory element being able to store instructions (e.g., software, logic, code, etc.) in non-transitory media such that the instructions are executed to carry out the activities described in this Specification.

A processor can execute any type of instructions associated with the data to achieve the operations detailed herein in this Specification. In one example, processors (e.g., processor 128) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, components in healthcare monitoring system 10 can include one or more memory elements (e.g., memory element 130, data store 84) for storing information to be used in achieving operations as outlined herein. These devices may further keep information in any suitable type of non-transitory storage medium (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs.

The information being tracked, sent, received, or stored in healthcare monitoring system 10 could be provided in any database, register, table, cache, queue, control list, or storage structure, based on particular needs and implementations, all of which could be referenced in any suitable timeframe. Any of the memory items discussed herein should be construed as being encompassed within the broad term ‘memory element.’ Similarly, any of the potential processing elements, modules, and machines described in this Specification should be construed as being encompassed within the broad term ‘processor.’

It is also important to note that the operations and steps described with reference to the preceding FIGURES illustrate only some of the possible scenarios that may be executed by, or within, the system. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain network access and protocols, healthcare monitoring system 10 may be applicable to other exchanges or routing protocols. Moreover, although healthcare monitoring system 10 has been illustrated with reference to particular elements and operations that facilitate the communication process, these elements, and operations may be replaced by any suitable architecture or process that achieves the intended functionality of healthcare monitoring system 10.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
receiving a request from a client for medical data in a network environment;
generating data rendering instructions for rendering the medical data as a visual display at the client, wherein the data rendering instructions include options to configure the visual display, wherein the visual display comprises a graphical representation of the medical data displayed according to a plurality of encounters, and visual aids that reveal information upon user selection;
delivering the data rendering instructions to the client; and
facilitating access to the medical data by the client.

2. The method of claim 1, wherein at least one data point of the graphical representation is selectable to reveal details about the data point.

3. The method of claim 1, wherein the visual display further comprises an action icon associated with each encounter, wherein the action icon is selectable to reveal one or more actions taken during the associated encounter.

4. The method of claim 1, wherein the visual display is configurable to display the medical data according to a plurality of dates corresponding to the encounters.

5. The method of claim 1, wherein the graphical representation indicates a type of each encounter, wherein the type of encounter is at least one selected from a group comprising: clinic, hospital, laboratory, web, imaging center, and other.

6. The method of claim 1, wherein the visual display is configurable to show a first item of the medical data plotted along a primary axis and a second item of the medical data plotted along a secondary axis.

7. The method of claim 1, wherein the visual display is configurable to show or hide an intelligent trend report, comprising an automatically calculated trend of the medical data in the visual display.

8. The method of claim 1, wherein the visual display includes a depiction of a target, wherein the graphical representation indicates whether the target has been met.

9. The method of claim 1, wherein the request is sent by a browser of the client to a server configured with an operating system comprising a plurality of self-contained interconnected modules and service layers for connecting proprietary and public systems together and extracting and translating data therefrom to enable them to cooperate in a software ecosystem while allowing flexible connections with both existing and new applications, wherein the browser accesses and renders the medical data according to the data rendering instructions.

10. The method of claim 9, wherein the browser updates the visual display according to configuration changes by a user input.

11. Logic encoded in non-transitory media that includes instructions for execution and when executed by a processor, is operable to perform operations comprising:
receiving a request from a client for medical data in a network environment;
generating data rendering instructions for rendering the medical data as a visual display at the client, wherein the data rendering instructions include options to configure the visual display, wherein the visual display comprises a graphical representation of the medical data displayed according to a plurality of encounters, and visual aids that reveal information upon user selection;
delivering the data rendering instructions to the client; and
facilitating access to the medical data by the client.

12. The logic of claim 11, wherein the visual display further comprises an action icon associated with each encounter, wherein the action icon is selectable to reveal one or more actions taken during the associated encounter.

13. The logic of claim 11, wherein the graphical representation indicates a type of each encounter, wherein the type of encounter is at least one selected from a group comprising: clinic, hospital, laboratory, web, imaging center, and other.

14. The logic of claim 11, wherein the visual display is configurable to show a first item of the medical data plotted along a primary axis and a second item of the medical data plotted along a secondary axis.

15. The logic of claim 11, wherein the request is sent by a browser of the client, wherein the browser accesses and renders the medical data according to the data rendering instructions.

16. An apparatus, comprising:
a receive module;
an instructions generator module;
a deliver module;
a memory element to store data; and
a processor to execute instructions associated with the data, wherein the receive module, the instructions generator module, the deliver module, the processor and the memory element cooperate such that the apparatus is configured for:
receiving a request from a client for medical data in a network environment;
generating data rendering instructions for rendering the medical data as a visual display at the client, wherein the data rendering instructions include options to configure the visual display, wherein the visual display comprises a graphical representation of the medical data displayed according to a plurality of encounters, and visual aids that reveal information upon user selection;
delivering the data rendering instructions to the client; and
facilitating access to the medical data by the client.

17. The apparatus of claim 16, wherein the visual display further comprises an action icon associated with each encounter, wherein the action icon is selectable to reveal one or more actions taken during the associated encounter.

18. The apparatus of claim 16, wherein the graphical representation indicates a type of each encounter, wherein the type of encounter is at least one selected from a group comprising: clinic, hospital, laboratory, web, imaging center, and other.

19. The apparatus of claim 16, wherein the visual display is configurable to show a first item of the medical data plotted along a primary axis and a second item of the medical data plotted along a secondary axis.

20. The apparatus of claim 16 wherein the request is sent by a browser of the client, wherein the browser accesses and renders the medical data according to the data rendering instructions.
